(19) United States
(12) Patent Application Publication
(10) Pub. No.: US 2004/0045399 A1
(43) Pub. Date: Mar. 11, 2004

(54) Torsional vibration damper for a crankshaft

(76) Inventor: Rod G. Hadi, South Lyon, MI (US)

Correspondence Address: FREUDENBERG-NOK GENERAL PARTNERSHIP, INTELLECTUAL PROPERTY DEPT., 47690 EAST ANCHOR COURT, PLYMOUTH, MI, 48170-2455, US

(21) Appl. No.: 10/649,527

(22) Filed: Aug. 27, 2003

Related U.S. Application Data
(60) Provisional application No. 60/409,627, filed on Sep. 10, 2002.

(51) Int. Cl. F16F 15/10

(52) U.S. Cl. 74/574

(57) ABSTRACT

An all-metal torsional vibration damper is more durable and less costly than conventional dampers, and can be fabricated without the need for the additional step of securing an elastomer to metal. A plurality of spokes, which interconnect inner and outer rings, can also have a preselected size, shape and configuration in order to accomplish the necessary torsional damping characteristics for a given rotating shaft application.

### BACKGROUND AND SUMMARY OF THE INVENTION

The invention relates generally to torsional vibration dampers for rotating shafts, especially those for use as crankshaft dampers for vehicle engines. More specifically, however, the invention relates to a damper that is formed completely of a metal or a metallic alloy.

Conventional dampers typically include at least one metallic component fixedly attached to an elastomeric component that provides a necessary torsional stiffness to achieve a required natural frequency. Although performing relatively well, the fabrication of such conventional dampers typically requires the additional step of bonding the elastomer to a metal component, molding the elastomer onto the metal component, or otherwise securing the elastomer in place, thus adding to the cost of the damper. Also, because the elastomeric component typically has a shorter life than that of the metal component, such conventional dampers usually have to be replaced well before the useful life of the metal component has ended.

The present invention seeks to improve upon such conventional dampers by providing an all-metal torsional vibration damper that is less costly than conventional dampers, that is more durable, and that can be fabricated without the need for the additional step of securing an elastomer to metal. The present invention also seeks to provide greater design control to achieve desired dampimg effects.

The present invention preferably provides a torsional vibration damper for damping vibrations on a rotating shaft. The torsional vibration damper includes an inner ring adapted to receive, and be fixed to, the shaft for rotation therewith, an outer ring generally concentric with said inner ring, a plurality of generally radial (or radial transverse) spokes interconnecting said inner ring and said outer ring. The masses, sizes, shapes and configurations of the inner and outer rings, as well as those of the spokes, can be preselected in order to allow the damper to achieve a desired torsional vibration-damping effect on the shaft as it is rotated.

Additional objects, advantages, and features of the present invention will become apparent from the following description and the appended claims, taken in conjunction with the accompanying drawing.

### BRIEF DESCRIPTION OF THE DRAWING

FIG. 1 is a perspective view of a torsional vibration damper according to the present invention.

### DETAILED DESCRIPTION OF THE PREFERRED EMBODIMENT

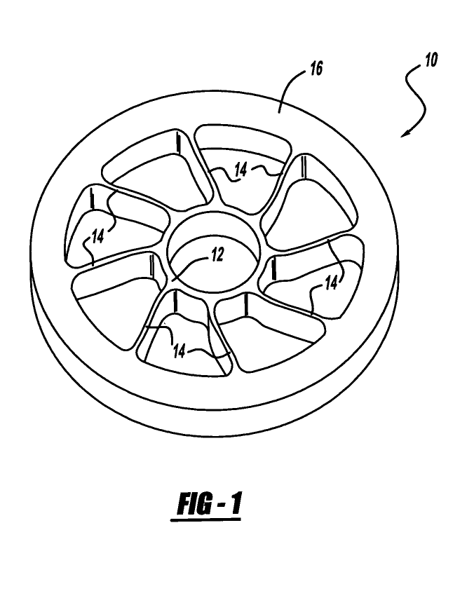

FIG. 1 illustrates one preferred example of a torsional vibration damper 10, according to the present invention, especially adapted for use on an engine crankshaft (not shown). It should be emphasized, however, that such engine crankshaft damper 10 is shown merely for purposes of example. Those skilled in the art will readily recognize that torsional vibration dampers according to the present invention are equally applicable in a wide variety of applications in addition to the illustrated engine crankshaft example.

The damper 10 includes an inner ring or arbor 12 interconnected with an outer ring 16 by a plurality of spokes 14 that extend generally radially (or radially transversely). Preferably, the inner ring 12, outer ring 16, and spokes 14 are formed as a unitary or one-piece member from a desired metal or metallic alloy, such as aluminum, steel, or other materials known to those skilled in the art.

The masses, shapes and geometries of the inner ring 12, outer ring 16, and spokes 14 are preselected to provide a desired torsional vibration-damping effect. For example, thicker and shorter (that is, having a relatively small radial length) spokes 14 provide a greater stiffness. Conversely thinner and longer (that is, having a relatively large radial length) spokes 14 provide a lesser stiffness. Also, increasing the number of spokes 14 can increase stiffness. In addition, the spokes 14 can be straight, curved or otherwise non-straight, and can intersect with the inner ring 12 or the outer ring 16 at any angle, or in any radial or other transverse relationship. These vibration-damping factors, of course, are interdependent with the relative masses of the various components.

The unitary construction of the damper 10 from a metal or metallic alloy thus provides a lower cost and longer lasting damper than conventional dampers formed from elastomeric materials combined with metal rings and the like, as well as offering the ability to carefully select the desired vibration damping characteristics for each specific application.

The foregoing discussion discloses and describes merely exemplary embodiments of the present invention for purposes of illustration only. One skilled in the art will readily recognize from such discussion, and from the accompanying drawings and claims, that various changes, modifications and variations can be made therein without departing from the spirit and scope of the invention as defined in the following claims.

What is claimed is:

1. A torsional vibration damper for damping vibrations on a rotating shaft, said torsional vibration damper comprising an inner ring adapted to receive the shaft for rotation therewith, an outer ring generally concentric with said inner ring, a plurality of radial spokes interconnecting said inner ring and said outer ring, said inner and outer rings and said spokes each having a preselected mass, size and shape in order to allow said damper to achieve a desired vibration damping effect on the shaft as it is rotated, said damper being formed entirely of a metallic material.

2. A torsional vibration damper according to claim 1, wherein said damper is an integrally-formed one-piece construction.

3. A torsional vibration damper, according to claim 1, wherein said damper is formed of an aluminum-containing material.

4. A torsional vibration damper, according to claim 1, wherein said damper is formed of a steel-containing material.

5. A torsional vibration damper for damping vibrations on a rotating shaft, said torsional vibration damper comprising an inner ring adapted to receive the shaft for rotation therewith, an outer ring generally concentric with said inner ring, a plurality of radial spokes interconnecting said inner ring and said outer ring, said inner and outer rings and said spokes each having a preselected mass, size and shape in order to allow said damper to achieve a desired vibration damping effect on the shaft as it is rotated, said damper being formed entirely of a metallic material, said damper being formed entirely of an aluminum-containing material and being formed as an integrally-formed one-piece construction.

6. A torsional vibration damper for damping vibrations on a rotating shaft, said torsional vibration damper comprising an inner ring adapted to receive the shaft for rotation therewith, an outer ring generally concentric with said inner ring, a plurality of radial spokes interconnecting said inner ring and said outer ring, said inner and outer rings and said spokes each having a preselected mass, size and shape in order to allow said damper to achieve a desired vibration damping effect on the shaft as it is rotated, said damper being formed entirely of a metallic material, said damper being formed entirely of a steel-containing material and being formed as an integrally-formed one-piece construction.
